(19) United States
(12) Patent Application Publication
(10) Pub. No.: US 2009/0007475 A1
(43) Pub. Date: Jan. 8, 2009

(54) Tool and Method for Organizing a Vertically Stacked Pile of Items

(76) Inventor: Linda R. Pollock, Minnetonka, MN (US)

Correspondence Address: SIRIUS STRATEGIC, LLC, 6769 W. SHADOW LAKE DR., LINO LAKES, MN, 55014, US

(21) Appl. No.: 12/085,109

(22) PCT Filed: Dec. 14, 2005
(86) PCT No.: PCT/US2005/045211

§ 371 Date: May 16, 2008

Related U.S. Application Data
(60) Provisional application No. 60/636,625, filed on Dec. 16, 2004.

(51) Int. Cl. B42F 21/00; B42F 7/12

(52) U.S. Cl. 40/641; 211/126.13

(57) ABSTRACT

A tool and a method of using the tool for organizing a vertically stacked pile of thin items. The method involves the steps of (i) obtaining a plurality of separator plates, each having at least one edge tab bearing indicia descriptive of a defined class of thin items, (ii) placing a thin item belonging to one of the defined classes of items either (a) atop that separator plate bearing indicia descriptive of the class to which the thin item belongs and underneath any other separator plates positioned above that separator plate, or (b) underneath that separator plate bearing indicia descriptive of the class to which the thin item belongs and atop any other separator plate positioned below that separator plate, and then (iii) repeating step (b), with a consistent selection of subpart (a) or (b) of step (ii), for a plurality of thin items.

This application claims the benefit of U.S. Provisional Application No. 60/636,625, filed Dec. 16, 2004.

### BACKGROUND

People are constantly looking for tools and methods to help them organize both business and personal items, particularly hard-copy documents. A wide variety of organizing products and services are available, ranging from simple file holders and folders holders to sophisticated tab and labeling systems. Professional organizers are also available for assisting those desiring to develop personal organizational skills and habits.

An organizational system widely practiced by many individuals is the piling of items into vertical stacks. The piling of items, such as hard-copy documents, is practiced by almost everyone, with some piling on a short-term basis until the items can be formally organized and others piling on a long-term basis as the formal organization system. Unfortunately, there are few tools available for assisting in the organization of vertically stacked piles. The organizational tools available in the marketplace are designed to organize horizontal rows of items rather than vertical stacks. In fact, organization by the horizontal row system, such as a filing system, is the most widely accepted organizational system, with piled items seen to be an inherently unorganized filing system.

Piles can quickly and easily become disorganized. They often hold items pertaining to multiple subjects, and tend to grow until they topple due to instability. In addition, it is often time consuming to locate a specific item stored within a pile and can be difficult to retrieve those items located at the bottom of the pile. However, human nature, learning styles, habit and simplicity of use often result in the long-term and/or short-term piling of items. In short, the horizontal row system of organization is preferred, but human nature tends to result in some vertically stacked piling of items.

Studies have shown that disorganization results in decreased productivity, lost time and frustration. Hence, a need exists for a tool and a method for organizing vertically stacked piles of items.

### SUMMARY OF THE INVENTION

A first aspect of the invention is a method for organizing a vertically stacked pile of thin items. The method involves the steps of (i) obtaining a plurality of thin, rigid separator plates, each separate and independent from the other separator plates and each having at least one edge tab bearing indicia descriptive of a defined class of thin items, (ii) placing a thin item belonging to one of the defined classes of items either (a) atop that separator plate bearing indicia descriptive of the class to which the thin item belongs and underneath any other separator plates positioned above that separator plate, or (b) underneath that separator plate bearing indicia descriptive of the class to which the thin item belongs and atop any other separator plate positioned below that separator plate, and then (iii) repeating step (b), with a consistent selection of subpart (a) or (b) of step (ii), for a plurality of thin items to form a vertically stacked pile of thin items with separator plates interspersed within the pile and separating different classes of thin items within the pile.

A second aspect of the invention is a tool for organizing a vertically stacked pile of items. The tool includes a plurality of separate and independent, thin, rigid separator plates. Each separator plate has at least one edge tab and one side tab bearing the same indicia descriptive of a defined class of thin items.

### BRIEF DESCRIPTION OF THE DRAWINGS

FIG. 1 is a top view of one embodiment of a separator plate.

FIG. 2 is front view of the separator plate shown in FIG. 1.

FIG. 3 is a top view of vertical stack of printed papers separated into classes by a set of the separator plates of the type shown in FIG. 1 with staggered end tabs and no side tabs.

FIG. 4 is an enlarged side view of a portion of the vertical stack shown in FIG. 3 arranged within a stacking tray with a corner registration guide.

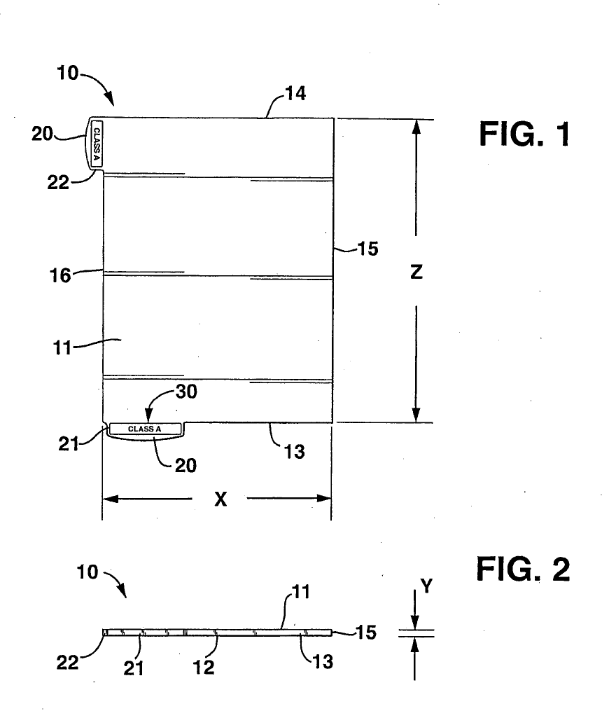

### DETAILED DESCRIPTION OF THE INVENTION INCLUDING A BEST MODE

### Definitions

As utilized herein, including the claims, the term “thin” means a thickness at least one order of magnitude smaller than the sum of the length and breadth.

### NOMENCLATURE

10 Separator Plate
11 Upper Major Surface of Separator Plate
12 Lower Major Surface of Separator Plate
13 Front End of Separator Plate
14 Back End of Separator Plate
15 Right Side of Separator Plate
16 Left Side of Separator Plate
20 Tab
21 End Tab
22 Side Tab
30 Indicia
40 Stacking Tray
41 Corner Registration Guide
100 Thin Items (e.g., Printed Sheets or Documents)
200 Vertically Stacked Pile
x Breadth
y Thickness
z Length
V Vertical Direction

### CONSTRUCTION

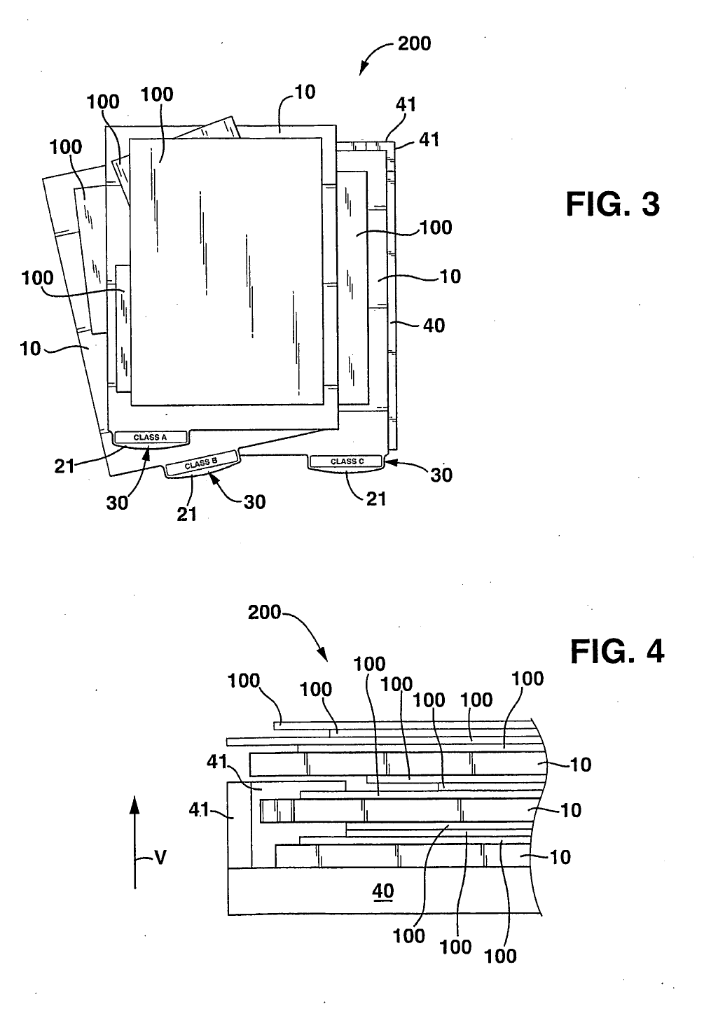

As shown in FIGS. 3 and 4, the invention is a method for organizing a pile 200 of thin items 100 stacked in a vertical direction V (i.e., a vertically stacked pile 200), commonly printed sheets or documents, by employing a plurality of individual separator plates 10 to identify designated types or categories of the thin items 100 and thereby encourage a user (not shown) to group the thin items 100 in the pile 200 by the designated types or categories.

The separator plates 10 are themselves thin items, with a preferred thickness y of about 0.5 to 5 mm, most preferably about 1 to 2 mm. The separator plates 10 have an upper major surface 11, a lower major surface 12, a front end 13, a back end 14, a right side 15 and a left side 16. The separator plates 10 have an end tab 21 and/or a side tab 22 (collectively referenced as tab 20) bearing indicia 30 descriptive of a defined class of thin items 100. When the separator plates 10 are provided with both an end tab 21 and a side tab 22, the indicia 30 imprinted upon the tabs 20 may be the same on both tabs 20 of each separator plate 10 (e.g., URGENT on the end tab 21 and URGENT on the side tab 22) or may be different but related as class and subclass (e.g., a set of three separator plates 10 with URGENT on the end tab 21 of all three plates 10 but PERSONAL, BUSINESS and OTHER on the side tabs 22).

The separator plates 10 are preferably rigid with major surfaces 11 and 12 which are moderately oversized relative to the size of the thin items 100 intended to be organized by the separator plates 10. Suitable materials of construction include specifically, but not exclusively, paperboard, cardboard, wood, rubber, plastic, metal, glass, and combinations of these materials.

The separator plates 10 can enhance the stability of a vertically stacked pile 200 of thin items 100 by employing separator plates 10 that are rigid, with major surfaces 11 and 12 which are moderately oversized relative to the size of the thin items 100 intended to be organized by the separator plates 10, and/or provide a high static coefficient of friction with the thin items 100 intended to be organized by the separator plates 10, (i.e., a static coefficient of friction of greater than 0.4). If desired, the static coefficient of friction of the major surfaces 11 and 12 of the separator plates 10 may be increased by texturing the surfaces 11 and 12 and/or coating the surfaces 11 and 12 with an anti-slip or high-friction coating material (not shown).

The separator plates 10 may be given any desired shape, from circular or oval to rectangular and anything in-between, including free-form shapes such as raindrop shaped or kidney shaped. Decorative openings may be provided through the separator plates 10 as desired (e.g., the trademark for the product or a fanciful depiction of a snowflake may be cut into the center portion (unnumbered) of each plate 10). The separator plates 10 are preferably sized with a breadth x and/or length z which is about 2 to 20 cm greater than the breadth and/or length of the thin items 100 intended to be organized by the separator plates 10. The separator plates 10 are most preferably sized with a breadth x and length z which is about 2 to 10 cm greater than the breadth and length of the thin items 100 intended to be organized by the separator plates 10. For example, separator plates 10 intended for use with a vertically stacked pile 200 of 8½ by 11 inch (21.6 cm by 27.9 cm) and/or A4 (21 cm by 29.7 cm) sheets of paper can functional well with a length z of between about 25 to about 40 cm, and a breadth x of between about 20 to about 30 cm, but preferably have a length z of between about 30 to about 35 cm, and a breadth x of between about 23 to about 27 cm.

The classes into which thin items 100 may be categorized are nearly endless, and depend in significant part on the types of thin items 100 to be separated. Such classes can be action classes, pending classes, sorting classes or filing classes. Table One below provides a nonexhaustive list of thin items 100 suitable for organization in a vertically stacked pile 200 using the separator plates 10, and exemplary organizational classes.

TABLE ONE

| THIN ITEM TYPE | CLASSES |
|---|---|
| Invoices | 1. Current |
| | 2. Overdue |
| | 1. Paid |
| | 2. Unpaid |
| Incoming Mail | 1. Read |
| | 2. Unread |
| | 1. Bills |
| | 2. Needs Reply |
| | 3. General |
| | 4. Junk Mail |
| Outgoing Mail | 1. Local Courier |
| | 2. USPS |
| | 3. FedEx |
| | 4. UPS |
| | 5. DHL |
| | 1. Intra-Company Mail |
| | 2. Outside the Office Mail |
| Contracts | 1. Drafts |
| | 2. Final |
| | 3. Signed |
| | 1. Leases for Property A |
| | 2. Leases for Property B |
| | 3. Leases for Property C |
| Personnel Files | 1. Hourly Employees |
| | 2. Salary Employees |
| | 1. A-G |
| | 2. H-M |
| | 3. N-Z |
| Insurance Claims | 1. Medical Provider A |
| | 2. Medical Provider B |
| | 3. Medical Provider C |
| | 1. Drug Claims |
| | 2. Dental Claims |
| | 3. Optometry Claims |
| | 4. Medical Claims |
| Coupons | 1. Meat |
| | 2. Fruits and Vegetables |
| | 3. Cereals |
| | 4. Canned Goods |
| | 5. Drinks |
| | 6. Paper Products |
| | 7. Dairy Products |
| | 8. Frozen Products |
| | 9. Breads and Baked Goods |
| | 1. Grocery |
| | 2. Fast Food and Restaurants |
| | 3. Department Stores |
| | 4. Convenience Stores |
| Photos | 1. Family |
| | 2. Friends |
| | 3. Vacations |
| | 3. Nature |
| | 4. Misc. |
| | 1. 2003 |
| | 2. 2004 |
| | 3. 2005 |
| | 4. 2006 |
| Vinyl Window Display Decorations | 1. Valentines Day |
| | 2. Easter |
| | 3. Mother's Day |
| | 4. Father's Day |
| | 3. 4^{th} of July |
| | 4. Thanksgiving |
| | 5. Christmas |
| | 6. New Years |
| | 1. Winter |
| | 2. Spring |
| | 3. Summer |
| | 4. Fall |

Indicia 30 is imprinted upon the tabs 20 to correspond to the classes to be used to group and separate thin items 100. The indicia 30 may be preprinted on the tabs 20 by the manufacturer, handwritten onto the tabs 20 by the user (not shown), printed onto adhesive labels (not shown) which are then adhered onto the tabs 20, etc. The tabs 20 may optionally be constructed from a material or provided with a coating effective for providing a write/erase upper major surface (unnumbered) on the tab 20 so that a user can change the classification system they use without replacing the set of separator plates 10.

The indicia 30 is preferably imprinted upon the tabs 20 upside-down as shown in FIGS. 1 and 3 (i.e., indicia 30 on an end tab 21 projecting from the front end 13 of a separator plate 10 is readable by a user viewing the end tab 21 from in front of the separator plate 10 and indicia 30 on a side tab 22 projecting from the left side 16 of a separator plate 10 is readable by a user viewing the side tab 22 from the left side of the separator plate 10).

The separator plates 10 are preferably provided as a set of from three to ten separator plates 10 with staggered tabs 20. Sets of labels (not shown) preprinted with common classes of thin items 100 (i.e., URGENT, ROUTINE, COMPLETED) can be packaged along with each set of separator plates 10 or as a separate item. The separator plates 10 in each set may all be the same color, of different colors, or color-coded (e.g., Red for URGENT, Yellow for ROUTINE, and Green for COMPLETED).

A stacking tray 40 may be provided as a visual indicator of the desired location for a vertically stacked pile 200. A corner registration guide 41 may be provided at one corner (unnumbered) of the stacking tray 40, preferably the right or left rear corner (unnumbered) to facilitate registration of the separator plates 10 and/or thin items 100 within a vertically stacked pile 200 stacked atop the stacking tray 40.

An added feature of the separator panels 10 is that the separator panels 10 are, also useful for organizing a horizontal row (not shown) of thin items 100 (i.e., thin items arranged at a 10° to 90° angle relative to the horizontal plane) in essentially the same manner as they are used for organizing vertically stacked piles 200 of thin items 100, so long as a mechanism is provided for supporting the thin items 100 as a horizontal row.

### USE

Upon obtaining a supply of the separator plates 10, the user places indicia 30 descriptive of a defined class of thin items 100 on at least one edge tab 20 of each separator plate 10, unless the tabs 20 on the separator plates 10 were preprinted with the desired indicia 30. A collection of thin items 100 can then be arranged into an organized vertically stacked pile 200 by, (i) sorting the thin items 100 within the collection according to the classes of items set forth on the separator plates 10 and either (a) placing the thin items 100 for each class of items atop that separator plate 10 bearing indicia 30 descriptive of that class and underneath any other separator plates 10 positioned above that separator plate 10, or (b) placing the thin items 100 for each class of items underneath that separator plate 10 bearing indicia 30 descriptive of that class and atop any other separator plate 1o positioned below that separator plate 10, and then (ii) repeating step (i), with a consistent selection of subpart (a) or (b) of step (i), for the collection of thin items 100. The result is a vertically stacked pile 200 of thin items 100 with separator plates 10 interspersed within the pile 200 and separating different classes of thin items 100 within the pile 200.

I claim:

1. A method for organizing a vertically stacked pile of thin items, comprising:
(a) obtaining a plurality of thin, rigid separator plates, each separator plate separate and independent from the other separator plates and each separator plate having at least one edge tab bearing indicia descriptive of a defined class of thin items,
(b) placing a thin item belonging to one of the defined classes of items either (i) atop the separator plate bearing the indicia descriptive of the class to which the thin item belongs and underneath any other separator plate positioned above the separator plate bearing the indicia descriptive of the class to which the thin item belongs, or (ii) underneath the separator plate bearing the indicia descriptive of the class to which the thin item belongs and atop any other separator plate positioned below the separator plate bearing the indicia descriptive of the class to which the thin item belongs,
(c) repeating step (b), with a consistent selection of subpart (i) or (ii), for a plurality of thin items to form a vertically stacked pile of thin items with separator plates interspersed within the pile and separating the different classes of thin items within the pile.

2. The method of claim 1 wherein the thin items are placed atop the separator plate bearing the indicia descriptive of the class to which the thin item belongs and underneath any other separator plate positioned above the separator plate bearing the indicia descriptive of the class to which the thin item belongs.

3. The method of claim 1 wherein the thin items are placed underneath the separator plate bearing the indicia descriptive of the class to which the thin item belongs and atop any other separator plate positioned below the separator plate bearing the indicia descriptive of the class to which the thin item belongs.

4. The method of claim 1 wherein at least some of the thin items are printed sheets.

5. The method of claim 1 wherein the separator plates are constructed from paperboard.

6. The method of claim 1 wherein the separator plates are constructed from plastic.

7. The method of claim 1 wherein each of the separator plates is a different color.

8. The method of claim 1 wherein the separator plates have an upper major surface and a lower major surface and both the upper and lower major surfaces provide a static coefficient of friction with a paper sheet of greater than 0.4.

9. The method of claim 1 wherein the separator plates have a thickness of between about 0.5 to about 5 mm, a length of between about 25 to about 40 cm, and a breadth of between about 20 to about 30 cm.

10. The method of claim 1 wherein the separator plates have a thickness of between about 1 to about 2 mm, a length of between about 30 to about 35 cm, and a breadth of between about 23 to about 27 cm.

11. The method of claim 1 wherein each of the separator plates has an end tab.

12. The method of claim 1 wherein each of the separator plates has a side tab.

13. The method of claim 1 wherein each of the separator plates have an end tab and a side tab, with both tabs bearing the same indicia.

14. The method of claim 1 wherein the tabs on the separator plates are staggered.

15. A tool for organizing a vertically stacked pile of items, comprising a plurality of separate and independent, thin, rigid separator plates, each separator plate having at least one edge tab and one side tab bearing indicia descriptive of a defined class of thin items.

16. The tool of claim 15 wherein each separator plate is imprinted with indicia describing different classes of thin items with both tabs on each separator plate imprinted with identical indicia.

17. The tool of claim 15 wherein the edge tab and side tab on each separator plate has a write/erase major surface.

18. The tool of claim 15 further comprising a stacking tray having a corner registration guide.

19. The tool of claim 15 wherein the indicia is upside-down.
